(19) United States
(12) Patent Application Publication
(10) Pub. No.: US 2011/0036423 A1
(43) Pub. Date: Feb. 17, 2011

(54) Relief Valve Device

(76) Inventors: Chen-Hsing Yi, Dajia Town (TW); Yen-Hui Huang, Dajia Town (TW)

Correspondence Address: KAMRATH & ASSOCIATES P.A., 4825 OLSON MEMORIAL HIGHWAY, SUITE 245, GOLDEN VALLEY, MN, 55422, US

(21) Appl. No.: 12/539,658

(22) Filed: Aug. 12, 2009

(51) Int. Cl. F16K 15/00

(52) U.S. Cl. 137/535

(57) ABSTRACT

A relief valve device comprising: a valve body and a valve mechanism. The valve body includes a axial channel, an air inlet end and an air outlet end. The air inlet end is defined as one end of the valve body. The air outlet end is defined as the other end of the valve body. A first washer is mounted in the air inlet end. A second washer is mounted in the air outlet end. The valve mechanism includes a washer, a poppet, a torsion spring, and a ring. The washer, the poppet, the torsion spring and the ring are mounted in the axial channel of the valve body in sequence. The ring is mounted to restrict the torsion spring, the poppet and the washer in the valve body. Thus, the present invention can effectively lower the cost and be easy to assemble and manufacture.

### BACKGROUND OF THE INVENTION

1. Field of Invention

The invention relates to valves and more particularly to a relief valve device.

2. Description of Related Art

As shown in FIGS. 4 to 5, conventional relief valve includes a valve body 40, a drain member 50 and a valve mechanism 60. One end of the valve body 40 is defined as an air inlet end 41. A first leak-proof washer 43 is mounted at the air inlet end 41. The other end of the valve body 40 is defined as an air outlet end 42. A second leak-proof washer 44 is mounted at the air outlet end 42.

The valve body 40 further includes a hexagonal flange 45. A threaded hole 451 is mounted on one side of the hexagonal flange 45. The drain member 50 is mounted in the threaded hole 451. The drain member 50 is designed for preventing the relief valve or other parts from explosion.

The valve mechanism 60 includes a washer 61, a poppet 62, a spring 63 and a screw 64. The washer 61, the poppet 62, the spring 63 are mounted in a axial channel 46 of the valve body 40 from the air outlet end 42 in sequence. The valve body 40 has an internal thread 461 for the screw 64 threadedly connecting to. The screw 64 can restrict the spring 63, the poppet 62 and the washer 61. The poppet 62 further has a shank 621 protruding out from the axial channel 46. The poppet 62 is pushed by the spring 63 to maintain in an airtight condition.

However, the structural design of the conventional relief valve leads the poppet 62 to be designed longer. It also has to machine the screw 64. Thus, the conventional relief valve consumes many raw materials and costs a lot.

Besides, in the conventional relief valve, the valve body 40 has to be machined to have an internal thread 461. The screw 64 has to have an external thread corresponding to the internal thread 461. It is time-consuming and difficult to manufacture and assemble. Thus, the need for improvement still exists.

### SUMMARY OF THE INVENTION

It is therefore one object of the invention to a relief valve device comprising: a valve body and a valve mechanism. The valve body includes a axial channel, an air inlet end and an air outlet end. One end of the valve body is defined as the air inlet end. The other end of the valve body is defined as the air outlet end. A first washer is mounted in the air inlet end. A second washer is mounted in the air outlet end.

The valve mechanism includes a third washer, a poppet, a torsion spring, and a ring. The third washer, the poppet, the torsion spring and the ring are mounted in the axial channel of the valve body in sequence. An annular trough is formed in the valve body and located in the axial channel for the ring embedding in. The ring is mounted to restrict the torsion spring, the poppet and the third washer in the valve body;

wherein one end of the torsion spring is mounted to contact the ring; the poppet further has a shank protruding out from the axial channel; the poppet is pushed by the torsion spring to maintain in an airtight condition, the poppet further has a recess for the other end of the torsion spring mounting in.

In a first aspect of the invention, the valve body further includes a hexagonal flange having a drain member. The drain member further includes a ring and a spacer. One side of hexagonal flange is mounted a threaded hole. The spacer, the ring and the drain member are mounted in the threaded hole in sequence.

By utilizing the invention, the following advantages are obtained. First, the present invention doesn't have to be machined to have the internal thread and the external thread. Therefore, the present invention can improve the machining efficiency effectively. The present invention can utilize the design of the ring to shorten the length of the valve body. Thus, the present invention can effectively lower the cost and be easy to assemble and manufacture.

The invention will become more obvious from the following description when taken in connection with the accompanying drawings.

### BRIEF DESCRIPTION OF THE DRAWINGS

FIG. 1 is an exploded view to show a relief valve device in accordance with the present invention;

FIG. 2 is a perspective view to show the relief valve device of the invention;

FIG. 3 is a cross-sectional view to show the relief valve device of the invention;

FIG. 4 is a perspective view to show a conventional valve device; and

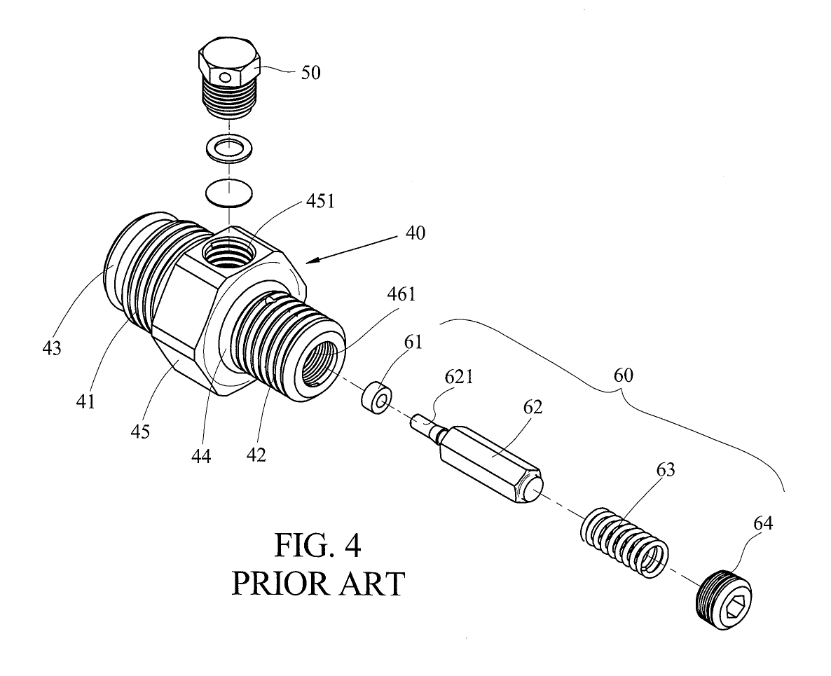

FIG. 5 is a cross-sectional view to show the conventional valve device.

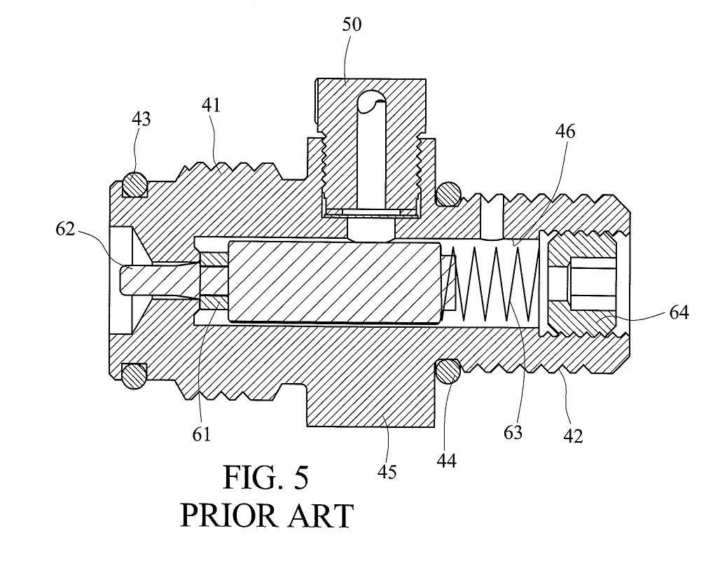

### DETAILED DESCRIPTION OF THE INVENTION

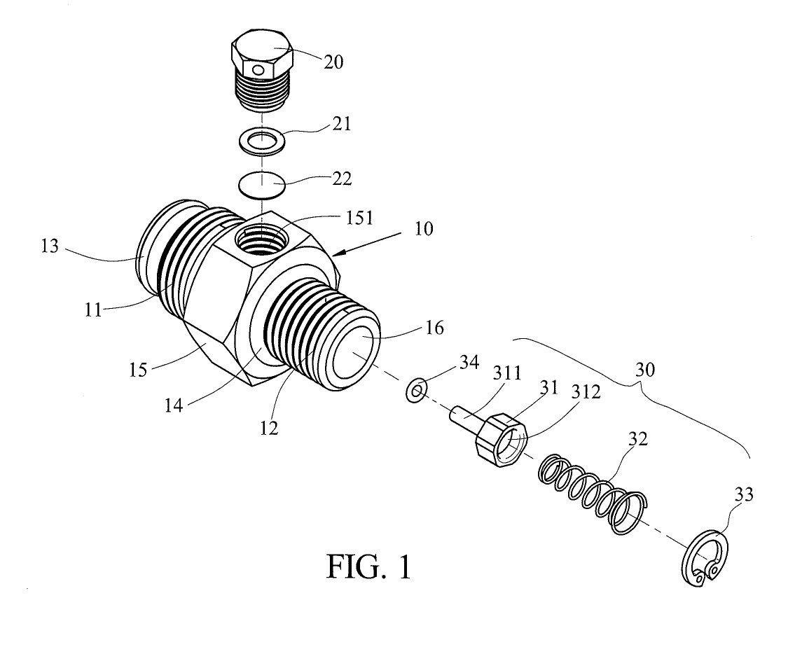

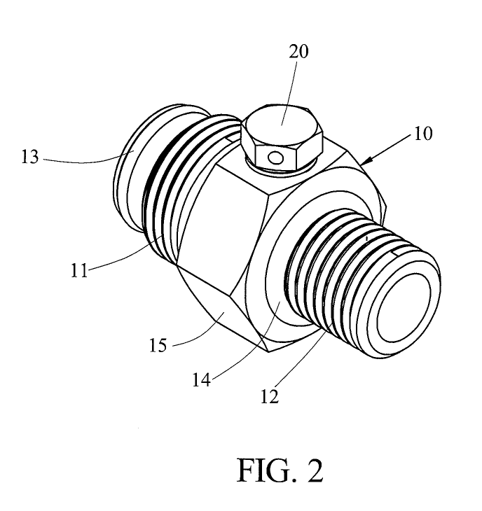

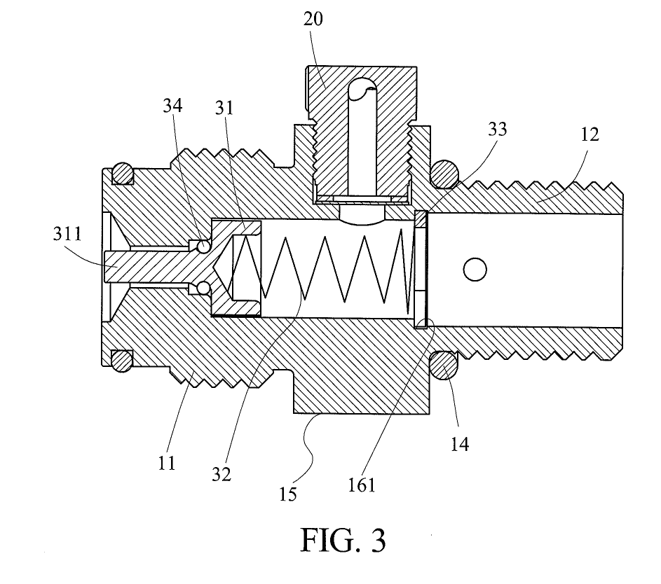

Referring to FIGS. 1 to 3, a relief valve device comprises a cylindrical valve body 10 and a valve mechanism 30. The valve body 10 includes an axial channel 16, an air inlet end 11 and an air outlet end 12. One end of the valve body 10 is defined as the air inlet end 11. The other end of the valve body 10 is defined as the air outlet end 12. A first washer 13 is mounted on the air inlet end 11. A second washer 14 is mounted on the air outlet end 12.

The valve mechanism 30 includes a third washer 34, a poppet 31, a torsion spring 32, and a c-clip 33. The third washer 34, the poppet 31, the torsion spring 32 and the c-clip 33 are mounted in the axial channel 16 of the valve body 10 in sequence. An annular trough 161 is formed in the valve body 10 and located in the axial channel 16 for the c-clip 33 embedding in. The c-clip 33 is mounted to restrict the torsion spring 32, the poppet 31 and the third washer 34 in the valve body 10.

One end of the torsion spring 32 is mounted to contact the c-clip 33; the poppet 31 further has a shank 311 protruding out from the axial channel 16; the poppet 31 is pushed by the torsion spring 32 to maintain in an airtight condition, the poppet 31 further has a recess 312 for the other end of the torsion spring 32 mounting in.

The valve body 10 further includes an intermediate hexagonal flange 15 with a threaded drain member 20 mounted thereon. In detail, the drain member 20 includes a ring 21 and a spacer 22. A threaded hole 151 is formed on one of six flats of the hexagonal flange 15. The spacer 22, the ring 121 and the drain member 20 are mounted in the threaded hole 151 in sequence.

By utilizing the invention, the following advantages are obtained. First, the present invention doesn't have to be machined to have the internal thread and the external thread. Therefore, the present invention can improve the machining efficiency effectively. The present invention can utilize the design of the ring to shorten the length of the valve body. Thus, the present invention can effectively lower the cost and be easy to assemble and manufacture.

While the invention herein disclosed has been described by means of specific embodiments, numerous modifications and variations could be made thereto by those skilled in the art without departing from the scope and spirit of the invention set forth in the claims.

1. A relief valve device comprising:
a cylindrical valve body including an axial channel having an annual through, an air inlet formed at one end of the channel, an air outlet end formed at the other end of the channel, a first washer mounted on the air inlet end, and a second washer mounted on the air outlet end;
a valve mechanism disposed in the channel and including a third washer, a poppet, a torsion spring, and a c-clip wherein the third washer, the poppet, the torsion spring, and the c-clip are mounted in the channel in sequence with the c-clip being disposed in the annular trough to retain the torsion spring, the poppet, and the third washer in place; and
a drain member mounted on the valve body,
wherein the poppet has a shank protruding out of the air inlet end, the poppet is urged by the torsion spring to sealingly block the channel when a pressure of input air is less than a predetermined pressure, and the poppet further has a head recess for anchoring one end of the torsion spring.

2. The relief valve device of claim 1, wherein the valve body further includes a hexagonal flange on an outer surface with the drain member mounted on the hexagonal flange.

3. The relief valve device of claim 2, wherein the hexagonal flange includes a threaded hole; and wherein the drain member is threaded and includes a ring and a spacer together for fastening the drain member in the threaded hole.
